(19) United States
(12) Patent Application Publication
(10) Pub. No.: US 2010/0010914 A1
(43) Pub. Date: Jan. 14, 2010

(54) APPARATUS AND METHOD FOR RECOMMENDING LECTURE TAILORED TO PERSON, AND CONNECTION TERMINAL THEREOF

(76) Inventor: Nam-Kyo Park, Anyang-si (KR)

Correspondence Address: MANNAVA & KANG, P.C., 11240 WAPLES MILL ROAD, Suite 300, FAIRFAX, VA, 22030, US

(21) Appl. No.: 12/519,262

(22) PCT Filed: Dec. 14, 2007
(86) PCT No.: PCT/KR07/06539

§ 371 Date: Jun. 15, 2009

(30) Foreign Application Priority Data
Dec. 15, 2006 (KR) 10-2006-0129035
Dec. 5, 2007 (KR) 10-2007-0125786

(51) Int. Cl. G06Q 50/00; G09B 7/00; G06Q 30/00; G06Q 20/00; G06K 5/00

(52) U.S. Cl. 705/26; 434/322; 705/1; 235/382

(57) ABSTRACT

Disclosed is an apparatus and method for recommending lectures tailored to each student by presenting lectures arranged based on a priority in consideration of learning ability, level, and region, which is different for each student, a user equipment for accessing to the apparatus, and a computer-readable recording medium for storing a program implementing the method. The apparatus includes: a membership manager for designating a region; a learning type decider for deciding learning tendency or learning level of the student; a lecture provider for providing a lecture that the student applied for among the lectures on a recommended lecture list extracted from a teacher database according to the learning tendency, the learning level, or the region; a quiz provider for providing lectures and quizzes related to the lectures again according to weak and strong parts of the student based on ‘answer to quiz related to the lecture’ submitted by the student.

### TECHNICAL FIELD

The present invention relates to an apparatus and method for recommending a lecture tailored for an individual student, and a user equipment therefor; and, more particularly, to a lecture recommending apparatus and method that can recommend a lecture appropriate for an individual student by providing a list of lectures arranged according to priority in consideration of learning tendency and learning level of the student and region that the student targets on, which may be different for each student, and a user equipment for accessing to the lecture recommending apparatus.

### BACKGROUND ART

Generally, off-line lectures at schools and institutes are unidirectional lectures given by one teacher to a plurality of students.

Since teachers deliver lectures of typical curriculum and lecture duration with an average level of difficulty, the lectures are uniform and do not take ability of each student into accounts. In other words, conventional off-line lectures hardly help students improve their learning level because they force students to stay in a passive role and do not reflect learning level of each student in view of learning difficulty and individual characteristics such as learning ability of each student.

Recently, people are paying attention to on-line lectures through the Internet, which can deviate the above problems. The on-line lecturing is provided with no regard to time and space for both teacher and student, and it is carried out in such a manner that students watch on-line lectures through the Internet and get an assessment for what they learn. The on-line lecturing also proceeds according to a teacher, which is similar to off-line lecturing, but the difference is that students can repeatedly study chapter-based lectures on their own. However, the level of the lectures is uniform and the lectures do not regard learning achievement of the students.

Since the conventional on-line lecturing is provided based on each teacher, which is similar to conventional off-line lecturing, it fails to provide information on whether characteristics and level of a lecture are appropriate for a student and whether the lecture reflects characteristics of regional school entrance exam or in-school achievement system of each school. Since the on-line lecturing is provided regardless of lecture purposes and lecture levels, which may be different according to each student, it is not efficient.

For example, a case where a lecture is provided targeting upper-level students whose school achievement are ranked from 1 to 15 and an on-line lecture is delivered at a level targeting those who are ranked from 5 to 10 will be described herein. In this case, those who are ranked higher than 5 feel the lecture easy and become less enthusiastic, while those who are ranked under 10 feel the lecture level difficult and do not completely understand what is dealt with in the lecture. Thus, the utility of the lecture degrades.

Those who are ranked higher than 5 and those ranked under 10 may decide that the on-line lectures are waste of time and money due to the degraded efficiency and quit using an on-line lecturing service.

Also, the conventional on-line lecturing has a shortcoming that it does not consider characteristics of school entrance exam for each school and region. To take an example, the conventional on-line lecturing has a shortcoming that it cannot reflect tendencies of entrance exams for universities or prominent high schools in regions other than metropolitan areas, because they are mainly directed to schools in the metropolitan areas.

Therefore, it is required to develop an method that can efficiently recommend optimal lectures to students according to learning tendency, learning level, and region of the students based on a priority and make them watch the lectures optimized to their characteristics, level and region and thereby improve the on-line lecturing.

### DISCLOSURE

### Technical Problem

Conventional on-line lecturing technology has a problem of low efficiency because it does not provide lectures tailored to a person, and it is the object of the present invention to overcome the problem.

It is another object of the present invention to provide an apparatus for recommending lectures suitable for an individual student by presenting a list of lectures arranged based on a priority order in consideration of learning ability, learning level, and region, which may be different according to each student, a method thereof, a user equipment for accessing to the tailored lecture recommending apparatus, and a computer-readable recording medium for storing a program that implements the tailored lecture recommending method.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an apparatus for recommending lectures, which includes: a membership manager for designating a region that a student with membership targets on; a learning type decider for deciding a learning tendency or learning level of the student; a lecture provider for providing a lecture that the student applied for among the lectures on a recommended lecture list extracted from a teacher database (DB) according to at least one selected from the group consisting of the learning tendency, the learning level, and the targeted region; a quiz provider for providing lectures and quizzes related to the lectures again according to weak and strong parts of the student based on ‘answer to quiz related to the lecture’ which is submitted by the student.

In accordance with another aspect of the present invention, there is provided a user equipment for accessing to learning materials provided by the lecture recommending apparatus recommending lectures tailored to a student, comprising: a tag reader, wherein the user equipment reads a tag attached to a predetermined learning material with the tag reader, accesses to the lecture recommending apparatus through wired/wireless Internet, receives a list of recommended lectures from the lecture recommending apparatus so that a lecture is selected.

In accordance with another aspect of the present invention, there is provided a user equipment for accessing to learning materials provided by the lecture recommending apparatus recommending lectures tailored to a student, which includes: a tag reader. Herein, the user equipment reads a tag attached to a predetermined learning material with the tag reader, accesses to the lecture recommending apparatus through wired/wireless Internet, receives optimal lectures or quizzes related to the lectures that satisfy at least one condition selected from the group consisting of learning tendency, learning level and targeted region of a student from the lecture recommending apparatus.

In accordance with another aspect of the present invention, there is provided a method for recommending lectures, which includes the steps of: designating a region that a student with membership targets on and checking learning tendency and learning level of the student; providing a lecture selected by the student from a recommended lecture list extracted from a teacher database according to at least one selected from the group consisting of the learning tendency, the learning level, and the targeted region of the student; and providing lectures and quizzes related to the lectures again according to weak and strong parts of the student based on a ‘quiz answer related to the quiz’ that is submitted by the student.

In accordance with another aspect of the present invention, there is provided a computer-readable recording medium for storing a program that implements a method in a lecture recommending apparatus with a processor. The method includes the steps of: designating a region that a student with membership targets on and checking learning tendency and learning level of the student; providing a lecture selected by the student from a recommended lecture list extracted from a teacher database according to at least one selected from the group consisting of the learning tendency, the learning level, and the targeted region of the student; and providing lectures and quizzes related to the lectures again according to weak and strong parts of the student based on a ‘quiz answer related to the quiz’ that is submitted by the student.

### ADVANTAGEOUS EFFECTS

The present invention can recommend lectures appropriate for each student by providing a list of lectures arranged based on a priority order in consideration of learning ability, learning level, and region, which may be different according to each student.

Also, the present can improve efficiency of on-line lecture not only by checking achievement of a student with membership through quiz, which is a simple exam for exercise, for a corresponding lecture content but also by re-providing a lecture and quiz therefor which are appropriate for weak parts and strong parts of the student.

In addition, the present invention can inform learning achievement of a student to the student or a parent of the student.

### BRIEF DESCRIPTION OF THE DRAWINGS

FIG. 1 illustrates an apparatus for recommending lectures tailored to a person in accordance with an embodiment of the present invention.

FIG. 2 shows an example of a teacher database (DB) shown in FIG. 1.

FIG. 3 is a flowchart describing a method for recommending lectures tailored to a person in accordance with an embodiment of the present invention.

### BEST MODE FOR THE INVENTION

The advantages, features and aspects of the invention will become apparent from the following description of the embodiments with reference to the accompanying drawings, which is set forth hereinafter. When it is considered that detailed description on a related art may obscure the points of the present invention, the description will not be provided herein. Hereinafter, specific embodiments of the present invention will be described in detail with reference to the accompanying drawings.

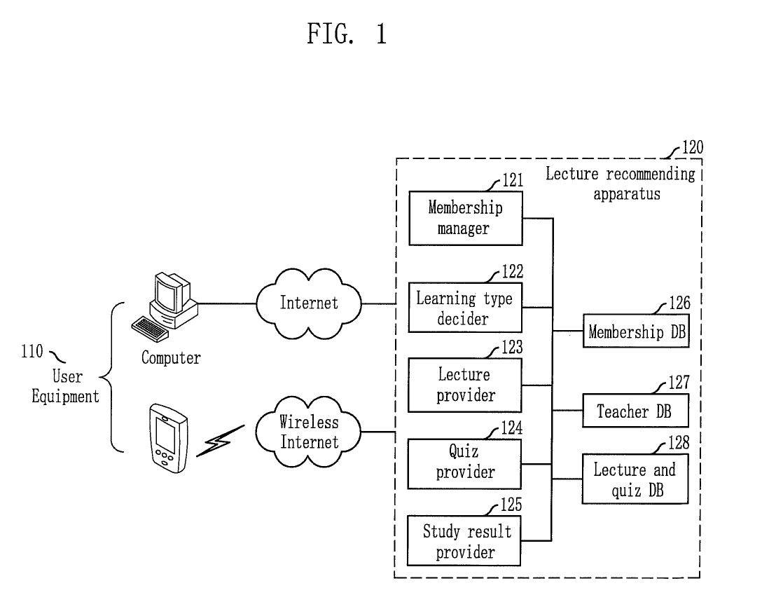

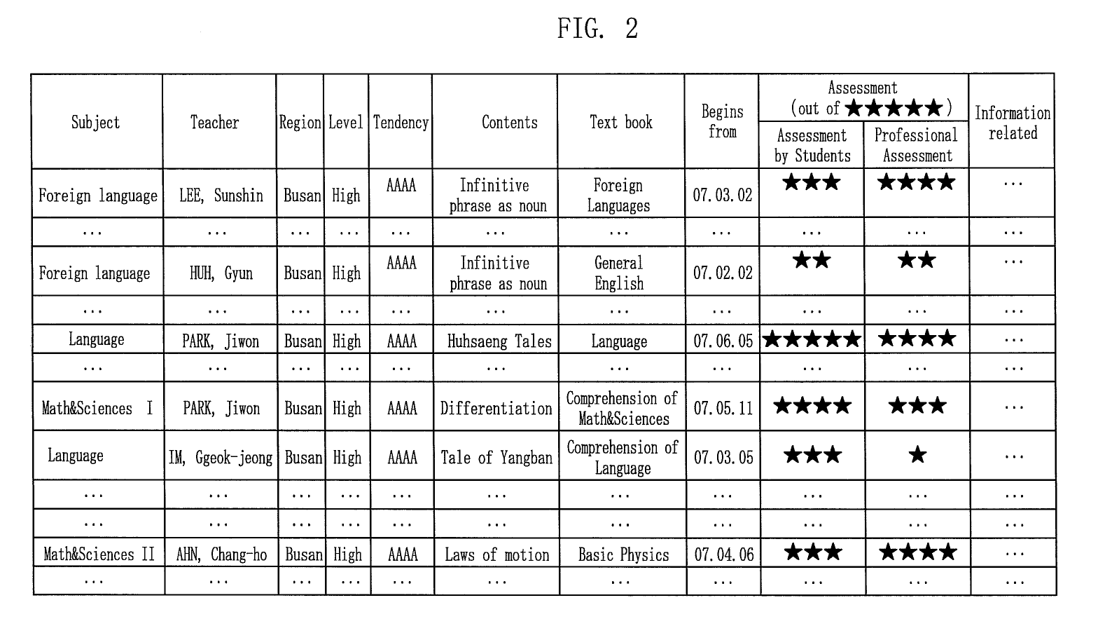

FIG. 1 illustrates an apparatus for recommending lectures tailored to a person in accordance with an embodiment of the present invention, and FIG. 2 shows an example of a teacher database (DB) shown in FIG. 1.

Referring to FIG. 1, the tailored lecture recommending apparatus 120 of the present invention, which will be simply referred to as a lecture recommending apparatus hereinafter, recommends lectures that are appropriate for a predetermined student on-line by providing a list of lectures arranged based on a priority in consideration of learning tendency, learning level, and region, which may be different for each student.

Herein, a user equipment 110 includes all terminals that a student use to access to the lecture recommending apparatus 120 through wired/wireless Internet and the user equipment 110 is equipped with a function of playing the lectures provided by the lecture recommending apparatus 120, which is a video play function. In short, the user equipment 110 receives video files for a predetermined lecture from the lecture recommending apparatus 120 in a streaming method or a download method and plays the video files. Examples of the user equipment 110 are personal computers, laptop computers, mobile phones, portable multimedia players (PMPs), smart phones, Digital Multimedia Broadcasting (DMB) terminals and the like.

The lecture recommending apparatus 120 includes a membership manager 121, a learning type decider 122, a lecture provider 123, a quiz provider 124, a study result provider 125, a membership database (DB) 126, a teacher DB 127, and a lecture and quiz DB 128.

The membership manager 121 provides an environment where members can easily access to the lecture recommending apparatus 120, and receives a series of requests from the members so that the constituent elements of the lecture recommending apparatus 120 of the present invention (which are the learning type decider 122, the lecture provider 123, the quiz provider 124, and the study result provider 125) can provide their functions to the members. Particularly, the membership manager 121 opens a website where students with membership can easily access, and provides the requests of the students inputted through the website to corresponding constituent elements of the lecture recommending apparatus 120 so as to recommend lectures tailored to each student. Herein, it is assumed that students referred herein have membership.

To be specific, the membership manager 121 provides a membership joining procedure for students to acquire membership. Herein, the membership manager 121 stores personal data inputted by students, such as name, resident registration number, home address, phone numbers of a student and his/her parent, membership identification (ID) and password therefor, access region information and the like in the membership DB 126. Subsequently, when a predetermined student attempts access, the membership manager 121 authenticates whether the student is a member who is registered through a lawful registration procedure, and provide the functions of the respective constituent elements of the lecture recommending apparatus 120 upon receipt of authentication.

Also, the membership manager 121 provides payment procedure, such as credit card payment and bank account remittance, so that the student can make a payment for a lecture he/she requested and watch the lecture.

The learning type decider 122 checks the learning tendency and learning level of the student. It may use the Myers-Briggs Type Indicator (MBTI) test to figure out the personality type of the student, a learning tendency test to see the characteristics and tendency of the student, a learning level test to examine learning level of subjects of the student, and an intelligence test to figure out intelligent ability of the student.

The learning type decider 122 can figure out the learning tendency of the student through the MBTI test or the learning tendency test, and it can check out the learning level of the student through the learning level test or the intelligence test. For example, the learning type decider 122 detects the learning tendency of the student in the MBTI test by checking which part of four different norms, which are extraversion-intraversion, sensing-intuition, thinking-feeling, and judging-perceiving, the student falls into.

The learning type decider 122 not only stores detailed test results in the membership DB 126 but also it stores the learning tendency and learning level decision result in the membership DB 126 as well to recommend lectures appropriate for the student.

In addition, the learning type decider 122 periodically checks the learning ability of the students and reflects the result to the membership DB 126.

The lecture provider 123 checks the learning tendency, learning level and target region of the student at the membership DB 126, checks a teacher corresponding to the data at the teacher DB 127, and provides a list of recommended lectures to the student. The recommended lectures of the list are arranged by the teacher DB 127 based on a priority order according to subjects, teachers, levels, tendencies, contents, text books, beginning dates, lecture assessment by students and professional lecture assessment conducted by experts.

Referring to FIG. 2, a case where the lecture provider 123 provides a list of recommended lectures to the members based on the data in the teacher DB 127 will be described. Herein, it is assumed that the learning tendency of a student is “AAAA” and the learning level is “high” while the region is “Busan.”

The lecture provider 123 searches the teacher DB 127 for a list of recommended lectures that satisfies conditions of the student, which are the learning tendency “AAAA”, the learning level “high”, and the region “Busan” and provides it to the student. According to subjects, it suggests lectures by “PARK, Jiwon” and “IM, Ggeok-jeong” for language; lectures by “LEE, Sunshin” and “HUH, Gyun” for foreign language; lecture of “HONG, Gil-dong” for mathematics and sciences I; and lecture of “AHN, Chang-ho” for mathematics and sciences II.

Also, the lecture provider 123 may provide a list of lectures arranged according to a search condition designated by the student.

When the student selects a lecture from the recommended lecture list, which may be called a lecture list, and signs up for the lecture, the lecture provider 123 makes the membership manager 121 execute a payment procedure for the lecture. Subsequently, the lecture provider 123 takes the lecture selected by the student out of the lecture and quiz DB 128 and provides it to the student.

In particular, the lecture provider 123 can provide the student with lectures proper to the school entrance exam tendency or an in-school exam tendency, which is different according to a region by providing a list of recommended lectures arranged based on a priority for each region. To take an example, there is a student who wants to apply for a provincial university, which means a university in a region out of a metropolitan area, and there is a student who wants to apply for a prominent high school of a special purpose in a predetermined region. They need to watch lectures suitable for entrance exam tendency of a corresponding region. Also, students need to watch lectures tailored for their regions to acquire high grade in their school exams.

According to an embodiment, the lecture provider 123 provides lectures on a section basis. For example, the lecture provider 123 provides lectures not on a chapter basis such as ‘infinitive phrases’ but on a section basis such as ‘infinitive phrase as noun,’ which is a part of the ‘infinitive phrases’ chapter. In short, it can be seen from FIG. 2 that a teacher called “LEE, Sunshin” gives a lecture on the ‘infinitive phrase as noun’ for a subject ‘foreign language.’ Herein, quiz for the lecture and answer to the quiz are also provided on a section basis.

Therefore, although students do not have time long enough to watch long lectures, they can directly watch lectures of sections at which they are weak without spending much time.

Meanwhile, the lecture provider 123 links the recommended lecture list to sample lectures of recommended teachers, lecture assessment by other students, professional lecture assessment done by experts, and detailed information of the lectures so that the students check the informations. Therefore, the students can watch the sample lectures, read the lecture assessment by other students and the professional assessment, or read the detailed information of corresponding lectures before they select lectures to watch.

Particularly, the lecture provider 123 generally assesses the lecture already assessed by the students and provides the general assessment result to other students. For example, when students assess whether the lectures they have watched were appropriate for their level (difficulty for each level), whether teachers delivered the lectures smoothly (smoothness), whether they easily understood the lectures (easiness), whether the lectures were interesting (interest), and whether the teachers showed specific know-how of their own, the lecture provider 123 collects the assessment and provides a general assessment result to other students, who refer to the general assessment result before selecting lectures to watch. Herein, the lecture provider 123 may delete lecture with bad feedback out of the recommended lecture list and do not show it on the recommended lecture list any more. The lecture provider 123 accumulates lecture assessments by students periodically, reflects it to the teacher DB 127 at a time or reflects it onto the teacher DB 127 in real-time whenever the students assess lectures.

Likewise, the lecture provider 123 generally assesses lectures already assessed by experts and provides a general assessment result to students. For example, when experts assesses characteristics of teachers and lectures, difficulty of lectures, and features of lectures, the lecture provider 123 collects the assessment results and provides students with the general professional assessment result. Herein, the lecture provider 123 accumulates the assessments by the experts periodically, reflects it onto the teacher DB 127 at a time or reflects it onto the teacher DB 127 in real-time whenever the experts assess lectures.

For example, in FIG. 2, the lecture presented by a teacher “LEE, Sunshin” acquired “★★★” out of “★★★★★” from students in the foreign languages, and acquired “★★★★” from experts.

After a lecture is provided to a student through the lecture provider 123, the quiz provider 124 takes quiz related to the lecture out of the lecture and quiz DB 128 and presents the quiz to the student. This is to let the student check his/her achievement in the lecture through the quiz and thus build up their level.

After analyzing the answer of the student to the quiz, the quiz provider 124 decides to which the student is strong and weak and provides lecture and quiz related to it again to the student.

In short, the quiz provider 124 provides a list of recommended lectures that can strengthen the weak part of the student and quizzes therefor to the student. This is to give the student an opportunity to figure out his/her weak parts through the lectures related to his/her weak part and strengthen the weak part by solving quizzes related to the weak part.

The quiz provider 124 also provides a list of recommended lectures or quizzes that can lift up the strong parts of the student detected in the lecture provider 123 into an upper level. It maximizes the efficiency of the on-line lecturing and the students can raise his/her level and jump up to a higher level in the part where they are already strong through the quizzes related to the strong part.

Meanwhile, the quiz provider 124 stores quiz results of students and quiz result analysis information in the membership DB 126 so that students can check them out whenever they want. It also stores the quiz result of the member and a result of counseling with a professional counselor on the quiz result analysis information in the membership DB 126.

The study result provider 125 provides students with an environment where the quiz results of the students and the quiz result analysis information that are stored in the membership DB 126 through the quiz provider 124 and a recommendation report after counseling with professional counselors can be outputted. Herein, the study result provider 125 issues the recommendation report to the students to check up their learning purposes or learning schedules in which subjects to be studied are sorted out on a section basis based on a priority order.

The study result provider 125 may check the quiz results of students and the quiz result analysis information every time and, when the learning level of a student drops, it informs the parent of the student of the level drop at a contact number of the parent that is stored in the membership DB 126. On the other hand, after checking the quiz result of a student and the quiz result analysis information, when the learning level of the student is improved, the study result provider 125 informs the parent of the student of the level improvement at a contact number of the parent that is stored in the membership DB 126 so that the parent can inspire the students with aspiration for study. It may also provide cyber money that can be spent on applying for other lectures. The study result provider 125 may reward the students in such a manner of raising the cyber classes of the students, growing up their cyber avatars, allowing them to buy cyber items, or presenting them a predetermined gift.

Meanwhile, the study result provider 125 may send examination paper tailored to the level of each student or audio-visual aids (such as flash video, moving pictures, audio materials, subsidiary videos, illustration and so fourth) to students to supplement the quiz result of the students and the quiz result analysis information. Herein, the study result provider 125 recommends materials that are acquired from the outside to support the learning of the students (such as external video, examination books, reference books, learning tools and so on), and it informs an on-line shopping mall for purchasing such external materials.

Herein, the examination books and audio-visual materials delivered to the students include predetermined tags for accessing to the lecture recommending apparatus 120 through the wired/wireless Internet, such as Radio Frequency Identification (RFID) tags, attached thereto. Herein, the user equipment 110 reads the tags with a tag reader, e.g., an RFID reader, accesses to the lecture recommending apparatus 120 through the wired/wireless Internet, and receives lists of recommended lectures or quizzes from the lecture recommending apparatus 120. Herein, the materials provided to the students are selected based on at least one among the learning level of students, region, and learning tendency. The materials may be provided in the form of a list, or a material corresponding to at least one among the learning level, region, and learning tendency of students.

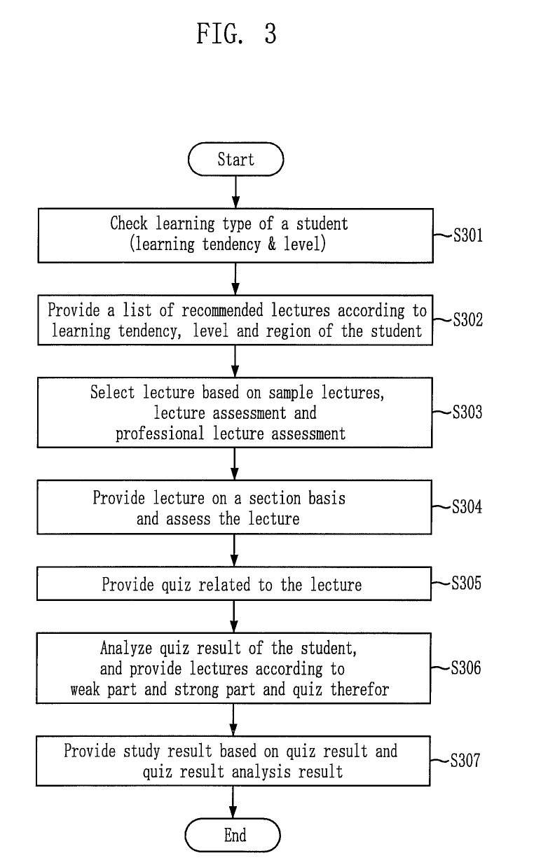

FIG. 3 is a flowchart describing a method for recommending lectures tailored to a person in accordance with an embodiment of the present invention.

Referring to FIG. 3, the lecture recommending apparatus 120 checks the learning type (which is learning tendency and learning level) of a student who signed up for a lecture service through a lawful procedure in step S301.

In step S302, the lecture recommending apparatus 120 provides a list of lectures recommended according to the learning tendency, learning level, and region of the student. The lectures of the list provided by the lecture recommending apparatus 120 are arranged based on a priority for each subject, teacher, region, level, tendency, content, text book, beginning date, lecture assessment by students, and professional lecture assessment with respect to the learning tendency, learning level, and region of the student.

Also, the lecture recommending apparatus 120 may provide a list of lectures arranged according to a search condition inputted by the student.

In step S303, the lecture recommending apparatus 120 presents the student sample lectures of the lectures in the recommended lecture list, lecture assessment by other students, and professional lecture assessment, when the student selects a lecture. Herein, the lecture recommending apparatus 120 provides a payment procedure for the student paying for the selected lecture in a typical payment method.

In step S304, the lecture recommending apparatus 120 provides the student with a lecture on a section basis, and has him/her make assessment after watching the lecture.

In step S305, the lecture recommending apparatus 120 provides the student with quiz related to the lecture. In step S306, the lecture recommending apparatus 120 analyzes the answer of the student to the quiz, and providing another lecture and quiz therefor again according to the weak part and strong part of the student. To sum up, the lecture recommending apparatus 120 provides a list of lectures and quizzes that can strengthen the weak part of a student or provides a list of lectures and quizzes that can raise the level of the student's strong part even higher. Thus, the lecture recommending apparatus 120 can maximize the efficiency of the on-line lecturing.

In step S307, the lecture recommending apparatus 120 informs the student of his/her achievement based on a quiz result and quiz result analysis information.

In other words, the lecture recommending apparatus 120 provides the student with an environment where the quiz result of the student, the quiz result analysis information, and a recommendation report on a counseling result between the student and a professional counselor can be outputted.

Particularly, the lecture recommending apparatus 120 examines the quiz result of the student and the quiz result analysis information for each lecture and, if the learning level of the student drops, it informs a parent of the student of the level drop. If the learning level of the student is improved, it also informs the parent of the improvement in order to inspire the student with aspiration or reward the student with cyber money that can be spent on applying for other lectures.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

While the present invention has been described with respect to certain preferred embodiments, it will be apparent to those skilled in the art that various changes and modifications may be made without departing from the scope of the invention as defined in the following claims.

What is claimed is:

1. An apparatus for recommending lectures, comprising:
a membership managing means for designating a region that a student with membership targets on;
a learning type deciding means for deciding a learning tendency or learning level of the student;
a lecture providing means for providing a lecture that the student applied for among the lectures on a recommended lecture list extracted from a teacher database (DB) according to at least one selected from the group consisting of the learning tendency, the learning level, and the targeted region;
a quiz providing means for providing lectures and quizzes related to the lectures again according to weak and strong parts of the student based on ‘answer to quiz related to the lecture’ which is submitted by the student.

2. The apparatus of claim 1, further comprising:
a study result providing means for providing the student with a study result based on a result of the quizzes and quiz result analysis information.

3. The apparatus of claim 1, wherein the teacher DB provides a list of recommended lectures arranged according to subject, teacher, region, level, tendency, content, text book, beginning date, lecture assessment by students, and professional lecture assessment according to each of the learning tendency, the learning level, and the targeted region.

4. The apparatus of claim 3, wherein the membership managing means executes a payment procedure, when the student signs up for a selected lecture.

5. The apparatus of claim 4, wherein the learning type deciding means executes any one selected from the group consisting of a Myers-Briggs Type Indicator (MBTI) test, a learning tendency test, a learning level test, and an intelligence test.

6. The apparatus of claim 5, wherein the lecture providing means provides the lecture on a section basis.

7. The apparatus of claim 6, wherein when the student signs up for the lecture, the lecture providing means provides at least one among a sample lecture of the lecture, lecture assessment by other students, and professional lecture assessment.

8. The apparatus of claim 7, wherein the lecture providing means provides an environment in which the student assesses the lecture after watching the lecture.

9. The apparatus of claim 2, wherein the study result providing means provides an environment in which a report on the quiz result of the student and the quiz result analysis information is outputted.

10. The apparatus of claim 9, wherein when the study result providing means confirms that the learning level of the student drops after checking the quiz result of the student and the quiz result analysis information for each lecture, the study result providing means informs a parent of the student of level drop.

11. A user equipment for accessing to learning materials provided by a lecture recommending apparatus of claim 1 recommending lectures tailored to a student, comprising:
a tag reader,
wherein the user equipment reads a tag attached to a predetermined learning material with the tag reader, accesses to the lecture recommending apparatus through wired/wireless Internet, receives a list of recommended lectures from the lecture recommending apparatus so that a lecture is selected.

12. A user equipment for accessing to learning materials provided by a lecture recommending apparatus of claim 1 recommending lectures tailored to a student, comprising:
a tag reader,
wherein the user equipment reads a tag attached to a predetermined learning material with the tag reader, accesses to the lecture recommending apparatus through wired/wireless Internet, receives optimal lectures or quizzes related to the lectures that satisfy at least one condition selected from the group consisting of learning tendency, learning level and targeted region of a student from the lecture recommending apparatus.

13. A method for recommending lectures, comprising the steps of:
designating a region that a student with membership targets on and checking learning tendency and learning level of the student;
providing a lecture selected by the student from a recommended lecture list extracted from a teacher database according to at least one selected from the group consisting of the learning tendency, the learning level, and the targeted region of the student; and
providing lectures and quizzes related to the lectures again according to weak and strong parts of the student based on a ‘quiz answer related to the quiz’ that is submitted by the student.

14. The method of claim 13, further comprising the step of:
informing the student of a study result based on a result of the quizzes and quiz result analysis information.

15. The method of claim 13, wherein the teacher DB provides a list of recommended lectures arranged according to subject, teacher, region, level, tendency, content, text book, beginning date, lecture assessment by students, and professional lecture assessment according to each of the learning tendency, the learning level, and the targeted region of the student.

16. The method of claim 15, wherein any one selected from the group consisting of a Myers-Briggs Type Indicator (MBTI) test, a learning tendency test, a learning level test, and an intelligence test is executed in the step of designating a region that a student targets on and checking learning tendency and learning level of the student.

17. The method of claim 16, wherein a payment procedure is executed in the step of providing a lecture selected by the student from the recommended lecture list, when the student signs up for a selected lecture.

18. The method of claim 17, wherein the lecture is provided on a section basis in the step of providing a lecture selected by the student from the recommended lecture list.

19. The method of claim 18, wherein when the student signs up for the lecture, at least one among a sample lecture of the lecture, lecture assessment by other students, and professional lecture assessment is provided in the step of providing a lecture selected by the student from the recommended lecture list.

20. The method of claim 19, wherein an environment in which the student assesses the lecture after watching the lecture is provided in the step of providing a lecture selected by the student from the recommended lecture list.

21. The method of claim 14, wherein an environment in which a report on the quiz result of the student and the quiz result analysis information is outputted is provided in the step of informing the student of a study result.

22. The method of claim 21, wherein when the quiz result of the student and the quiz result analysis information are checked for each lecture and the learning level of the student drops, a parent of the student is informed of level drop.

23. A computer-readable recording medium for storing a program that implements a method in a lecture recommending apparatus with a processor, the method comprising the steps of:
designating a region that a student with membership targets on and checking learning tendency and learning level of the student;
providing a lecture selected by the student from a recommended lecture list extracted from a teacher database according to at least one selected from the group consisting of the learning tendency, the learning level, and the targeted region of the student; and
providing lectures and quizzes related to the lectures again according to weak and strong parts of the student based on a ‘quiz answer related to the quiz’ that is submitted by the student.
